(19) United States
(12) Patent Application Publication
(10) Pub. No.: US 2008/0255950 A1
(43) Pub. Date: Oct. 16, 2008

(54) METHOD AND SYSTEM FOR THE SALE OF PRODUCTS THROUGH THE INTERNET BY DISPLAYING ADVERTISING BANNERS

(76) Inventor: Giovanni Giuffrida, Catania (IT)

Correspondence Address: KLARQUIST SPARKMAN, LLP, 121 SW SALMON STREET, SUITE 1600, PORTLAND, OR, 97204, US

(21) Appl. No.: 12/101,407

(22) Filed: Apr. 11, 2008

(30) Foreign Application Priority Data
Apr. 11, 2007 (IT) BO2007A 000261

(51) Int. Cl. G06Q 30/00

(52) U.S. Cl. 705/14

(57) ABSTRACT

A method and a system for the sale of products through the Internet by displaying advertising banners in a web page; the display system has: a server computer connected to the Internet; a memory space, stored in which is an advertising-banner template, a plurality of advertising messages, and for each advertising message at least one respective criterion of choice; a processing device of the server computer for determining, following upon a request for loading the web page by a remote client device connected to the Internet, at least one characteristic of the navigation context of the remote client device itself, a comparison device of the server computer for comparing the characteristic of the navigation context with the criteria of choice; a generation device of the server computer for generating dynamically an advertising banner using the advertising-banner template; and a communication device of the server computer for transferring the advertising banner to the remote client device.

### CROSS REFERENCE TO RELATED APPLICATIONS

This application claims the benefit of Italian Patent Application No. BO2007A 000261, filed Apr. 11, 2007, the entire contents of which hereby are incorporated by reference.

### TECHNICAL SECTOR

The present invention relates to a method and a system for the sale of products through the Internet by displaying advertising banners.

### PRIOR ART

For some years now there has been a constant growth in the sale of goods or services made available to consumers through the Internet, and in particular through advertising announcements that propose the purchase of goods or services and that are displayed superimposed on the web pages visited during navigation through the Internet. One of the tools used for entering an advertising announcement within a web page is constituted by advertising banners, which appear immediately upon the first loading of the web page, are superimposed on or set alongside the contents of the web page, can close automatically after a certain time interval or else can be closed by the user, and invite the user to click on them for opening a new web page, through which a commercial message (i.e., one containing a proposal for electronic purchase of goods or services) is proposed. In other words, the main purpose of an advertising banner is to generate accesses to a website of interest via images with a corresponding link associated to and displayed on sites and/or portals of other companies.

Various systems for display of advertising banners are known, which may envisage a display of a static type; i.e., upon opening of a web page, the same advertising contents, or else contents of a dynamic type always appear, or, in other words, upon opening of a web page variable advertising contents generally appear to enable a number of advertisers to share the same web page.

In the case of a display of contents of a dynamic type, stored in a database is a set of advertising messages, which are alternative to one another, and a manager sees, at each opening of the web page, to creating a banner containing one of the advertising messages contained in the library. The choice of the advertising message to be displayed is made on the basis of various criteria, amongst which, for example, the uniformity of distribution (i.e., a certain number of passages is guaranteed to all the advertising announcements), the data regarding opening of the pages (for example, certain advertising announcements are displayed only at the weekend), and the time of opening of the page (for example, certain advertising announcements are displayed only at mealtimes).

However, in the last few years traditional banners of the same type as the ones described above have encountered a progressive decrease in the number of clicks (or, rather, the click-rate) by users on account of the poor appeal of the advertising message. In other words, a generic advertising message is proposed unchanged to a high number of users of the Internet, but only a minor part of said users is actually interested in the advertising message, and hence the overall effectiveness of the advertising message proves very low.

### DESCRIPTION OF THE INVENTION

The aim of the present invention is to provide a method and a system for the sale of products through the Internet by displaying advertising banners that will be free from the drawbacks described above and will be at the same time easy and inexpensive to provide.

Provided according to the present invention are a method and a system for the sale of products through the Internet by displaying advertising banners as claimed in the attached Claims.

### BRIEF DESCRIPTION OF THE DRAWINGS

The present invention will now be described with reference to the annexed figure of drawing, which illustrates a non-limiting example of embodiment thereof, in particular the attached figure illustrates a system for the sale of products through the Internet by displaying advertising banners provided in accordance with the present invention.

### PREFERRED EMBODIMENTS OF THE INVENTION

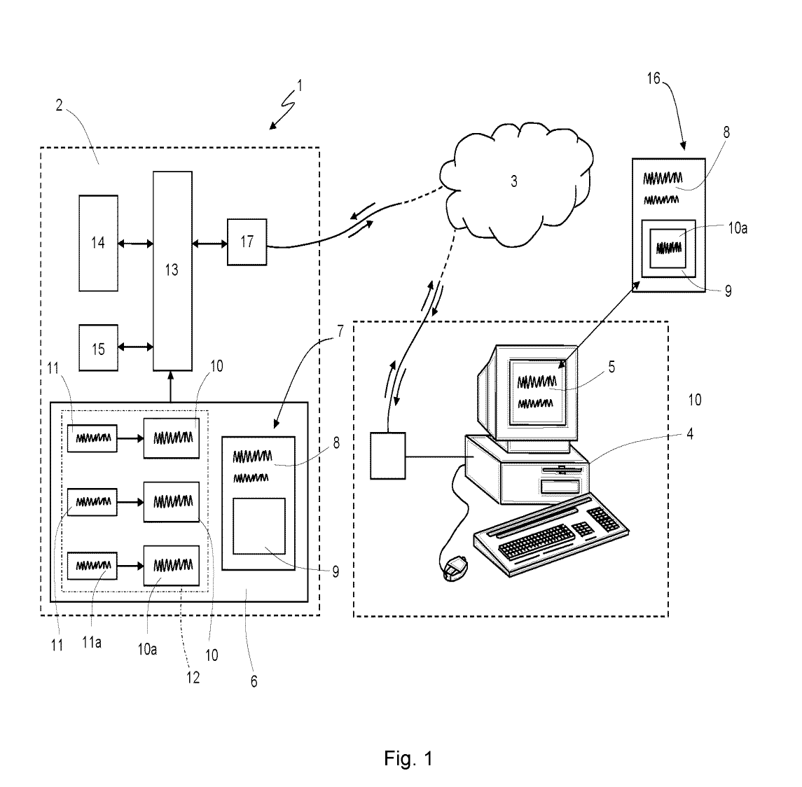

In FIG. 1, the reference number 1 designates as a whole a system for the sale of products through the Internet by displaying advertising banners. The display system 1 comprises a server computer 2 connected to the Internet 3 and designed to interact with at least one remote client device 4, which is also connected to the Internet 3 and is able to navigate in the Internet for displaying web pages 5. For example, the remote client device 4 can be a computer as illustrated in the attached figure or else a portable device such as a cellphone or a palm-top, which connects up to the Internet in wireless mode.

Present in the server computer 2 is a memory space 6 (a RAM and/or a hard disk), stored in which is an advertising-banner template 7 comprising: a fixed pre-compiled part 8 and a personalizable empty part 9; a plurality of advertising messages 10 suited to being entered in the personalizable empty part 9 of the advertising-banner template 7; and for each advertising message 10 at least one respective criterion 11 of choice. It should be noted that the personalizable empty part 9 of the advertising-banner template 7 could be provided for housing simultaneously a number of advertising messages 10, which is not fixed; i.e., the personalizable empty part 9 of the advertising-banner template 7 can house a variable number of advertising messages 10 using, if necessary, pre-defined filling images. Normally, the advertising messages 10 and the criteria 11 of choice are organized in a relational database 12 stored in the memory space 6.

Preferably, the advertising messages 10 are of a commercial type; i.e., they contain proposals for electronic purchase of goods or services.

The server computer 2 implements:

a processing device 13 (which is normally defined by a software algorithm) for determining, following upon a request for loading a web page 5 by the remote client device 4, at least one characteristic of the navigation context of the remote client device 4 itself;

a comparison device 14 (which is normally defined by a software algorithm) for comparing the characteristic of the navigation context with the criteria 11 of choice for determining the criterion/criteria 11a of choice, and hence the respective advertising message/messages 10a, which has/have the maximum correspondence with the characteristic of the navigation context;

a generation device 15 (which is normally defined by a software algorithm) for dynamic generation of an advertising banner 16 using the advertising-banner template 7 and entering in the personalizable empty part 9 of the advertising-banner template 7 itself the advertising message/messages 10a, the criterion/criteria 11 of choice of which has/have the maximum correspondence with the characteristic of the navigation context; and

a communication device 17 (which is normally defined by a software algorithm) for transferring the advertising banner 16 to the remote client device 4 so as to superimpose the advertising banner 16 on (or set it alongside) the web page 5.

During a step of configuration of the display system 1, stored in the memory space 6 of the server computer 2 are the advertising-banner template 7, the plurality of advertising messages 10, and for each advertising message 10 at least one respective criterion 11 of choice. Next, during normal operation of the display system 1, the server computer 2 carries out cyclically the following steps for each web page 5:

determining, following upon a request for loading the web page 5 by the remote client device 4, at least one characteristic of the navigation context of the remote client device 4 itself;

comparing the characteristic of the navigation context with the criteria 11 of choice for determining the criterion/criteria 11a of choice, and hence the respective advertising message/messages 10a, which has/have the maximum correspondence with the characteristic of the navigation context;

generating dynamically an advertising banner 16 using the advertising-banner template 7 and entering into the personalizable empty part 9 of the advertising-banner template 7 itself the advertising message/messages 10a, the criterion/criteria 11 of choice of which has/have the maximum correspondence with the characteristic of the navigation context; and

transferring the advertising banner 16 to the remote client device 4.

As has been said previously, the advertising banner 16 is generated dynamically by entering into the personalizable empty part 9 of the advertising-banner template 7 a number (normally equal to or greater than one) of advertising messages 10a, the criteria 11a of choice of which have the highest correspondence with the characteristic of the navigation context.

According to a possible embodiment, the characteristic of the navigation context of the remote client device 4, which is determined following upon a request for loading the web page 5, is a characteristic proper to the remote client device 4 itself and in particular can be the geographical location of the remote client device 4 (in this case, the criteria 11 of choice are criteria 11 of choice of a geographical type) or else can be the habit of navigation via the remote client device 4 (in this case, the criteria 11 of choice are criteria 11 of choice of a commodity type). The habit of navigation via the remote client device 4 is a function of various data such as the type of web pages 5 loaded in the past by the remote client device 4, the contents of said web pages 5, the information that has been read in the past, and the banners that have been clicked on in the past; said data can be supplied through cookies previously loaded into the remote client device 4.

According to an alternative embodiment, the characteristic of the navigation context that is determined following upon a request for loading of the web page 5 is represented by the contents of the web page 5 itself. Said operating mode has the undoubted advantage of not requiring any type of information of the remote client device 4 apart from the request for loading the web page 5; in fact, certain data of the remote client device 4 may not be available or may in any case be considered reserved on the basis of privacy laws and cannot hence be legally used.

Obviously, to each advertising message 10 there can be associated a number of criteria 11 of choice that are used alternatively to one another or in association with one another by the comparison device 14. It should also be noted that, if the characteristic of the navigation context does not correspond sufficiently to any criterion 11 of choice, the display system 1 could decide not to transfer any advertising banner to the remote client device 4 or else to transfer a default advertising banner having the sole purpose of filling, in the web page 5, the space dedicated to the advertising banner.

By way of example, the display system 1 described above can be used for advertising travel, presenting to each consumer, via the advertising banner 16, only the travel proposals that start from the town where the consumer himself resides (hence using criteria 11 of choice of a geographical type).

Once again by way of example, the display system 1 described above can be used for marketing articles (books, etc.) of an Internet shop or an on-line-auction site proposing to each consumer, via the advertising banner 16, only the articles that may potentially be of interest for the consumer himself.

According to a preferred embodiment aimed at the marketing of goods or services, each advertising message 10 contains the description of a good or service, whilst the corresponding criteria 11 of choice contain characteristics of the good or service. In this case, the criteria 11 of choice of an advertising message 10 containing the description of a good or service comprise all the information that is potentially useful for customizing the message properly; for example, the criteria 11 of choice of an advertising message 10 containing the description of a good or service can comprise also the availability of the good or service, whether the good or service is or not of a promotional nature, and the estimated times of delivery of the good or service. In this case, the relational database 12 containing the advertising messages 10 and the criteria 11 of choice is substantially a catalogue of the goods or services that are to be sold.

The display system 1 described above is simple and inexpensive to implement and is particularly efficient in the use of the graphic and computer resources in so far as it requires the creation and storage of just one advertising-banner template 7 that is each time personalized by modifying only the personalizable empty part 9. In this way, it is possible to have a very high number of advertising messages 10 (typically constituted only by text information that has a very low memory occupation) without heavy use of the resources of the server computer 2. In this way, the display system 1 described above is particularly suitable for marketing a high number of articles contained in an Internet shop or in an on-line-auction site.

In addition, the display system 1 described above enables display of advertising banners 16 that absolutely targeted at the consumers who are navigating. In this way, the advertising banners 16 displayed are not intrusive in the “on-line life” of the consumer, but rather help the consumer to find what he is looking for at the moment when he seeks it so as to attempt to create a relationship that will increase the value for all the parties involved (for the consumer, who finds, without having to make a big cognitive effort and without any expenditure of time, the information that is really of interest to him, and for the firm, which in this way succeeds in not dispersing its own advertising effort and increases the value of competence and quality perceived by the consumer).

1. A method for the sale of products through the Internet by displaying advertising banners in a web page; the method comprises the steps of:
storing, in a memory space of a server computer connected to the Internet, an advertising-banner template comprising a fixed pre-compiled part and a personalizable empty part;
storing, in the memory space of the server computer, a plurality of advertising messages suited to being entered in the personalizable empty part of the advertising-banner template;
storing in the memory space and for each advertising message at least one respective criterion of choice;
determining, following upon a request for loading the web page by a remote client device connected to the Internet, at least one characteristic of the navigation context of the remote client device itself;
comparing the characteristic of the navigation context with the criteria of choice for determining at least one criterion of choice, and hence at least one respective advertising message, having the maximum correspondence with the characteristic of the navigation context;
generating dynamically an advertising banner using the advertising-banner template and entering, into the personalizable empty part of the advertising-banner template itself, at least one advertising message, the criterion of choice of which has the maximum correspondence with the characteristic of the navigation context; and
transferring the advertising banner to the remote client device.

2. The method according to claim 1, wherein the characteristic of the navigation context of the remote client device that is determined following upon a request for loading the web page is a characteristic proper to the remote client device itself.

3. The method according to claim 2, wherein the characteristic of the navigation context is the geographical location of the remote client device itself and the criteria of choice are criteria of choice of a geographical type.

4. The method according to claim 2, wherein the characteristic of the navigation context is the habit of navigation through the remote client device and the criteria of choice are criteria of choice of a commodity type.

5. The method according to claim 4, wherein the habit of navigation through the remote client device is a function of the type of web pages loaded in the past by the remote client device.

6. The method according to claim 5, wherein the type of web pages loaded in the past by the remote client device is supplied to the server computer through cookies loaded previously into the remote client device.

7. The method according to claim 1, wherein the characteristic of the navigation context that is determined following upon a request for loading the web page is the contents of the web page itself.

8. The method according to claim 1, wherein no advertising banners are transferred to the remote client device if the characteristic of the navigation context does not correspond sufficiently to any criterion of choice.

9. The method according to claim 1, wherein the advertising banner is generated dynamically by entering into the personalizable empty part of the advertising-banner template a plurality of advertising messages, the criteria of choice of which have the highest correspondence with the characteristic of the navigation context.

10. The method according to claim 9, wherein the personalizable empty part of the advertising-banner template can house a variable number of advertising messages.

11. The method according to claim 1, wherein the advertising messages and the criteria of choice are stored in a relational database.

12. A system for the sale of products through the Internet by displaying advertising banners in a web page;
the display system comprising:
a server computer connected to the Internet;
a memory space, managed by the server computer and stored in which is an advertising-banner template comprising a fixed pre-compiled part and a personalizable empty part, a plurality of advertising messages suited to being entered into the personalizable empty part of the advertising-banner template, and, for each advertising message, at least one respective criterion of choice;
a processing device of the server computer for determining, following upon a request for loading the web page by a remote client device connected to the Internet, at least one characteristic of the navigation context of the remote client device itself;
a comparison device of the server computer for comparing the characteristic of the navigation context with the criteria of choice for determining at least one criterion of choice, and hence at least one respective advertising message, having the maximum correspondence with the characteristic of the navigation context;
a generation device of the server computer for generating dynamically an advertising banner using the advertising-banner template and entering, into the personalizable empty part of the advertising-banner template itself, at least one advertising message, the criterion of choice of which has the maximum correspondence with the characteristic of the navigation context; and
a communication device of the server computer for transferring the advertising banner to the remote client device.
